(19) United States
(12) Patent Application Publication
(10) Pub. No.: US 2025/0134745 A1
(43) Pub. Date: May 1, 2025

(54) UPPER LIMB REHABILITATION DEVICE

(71) Applicant: NATIONAL CHENG KUNG UNIVERSITY, Tainan City (TW)

(72) Inventors: Hsiu-Yun HSU, Tainan City (TW); Li-Chieh KUO, Tainan City (TW); Kang-Chin YANG, Pingtung County (TW); Ping-Han CHUANG, Tainan City (TW)

(21) Appl. No.: 18/418,791

(22) Filed: Jan. 22, 2024

(30) Foreign Application Priority Data
Oct. 27, 2023 (TW) 112141312

(51) Int. Cl. A61H 1/02

(52) U.S. Cl. CPC A61H 1/0285; A61H 2201/1215; A61H 2201/1635; A61H 2201/1671; A61H 2201/1676; A61H 2201/5007; A61H 2201/5038; A61H 2201/5066; A61H 2201/5069

(57) ABSTRACT

An upper limb rehabilitation device includes a support mechanism, a flexion and extension rehabilitation mechanism, and a twist rehabilitation mechanism. The flexion and extension rehabilitation mechanism includes a sliding seat unit mounted on and movable forwardly and rearwardly relative to the support mechanism, and an arm rest seat mounted on the sliding seat unit for an arm of an upper limb of a patient to rest thereon. The arm rest seat is configured to be actuated by a flexion and extension movement of the arm of the upper limb of the patient to drive forward and rearward movement of the sliding seat unit relative to the support mechanism. The twist rehabilitation mechanism includes a handgrip unit mounted on the sliding seat unit and rotatable leftward and rightward relative to the same for a hand of the upper limb of the patient to grip.

### CROSS-REFERENCE TO RELATED APPLICATION

This application claims priority to Taiwanese Invention Patent Application No. 112141312, filed on Oct. 27, 2023.

### FIELD

The disclosure relates to a rehabilitation device, and more particularly to an upper limb rehabilitation device.

### BACKGROUND

A conventional limb rehabilitation treatment involves a professional rehabilitation therapist using bare hands and rehabilitation equipment to rehabilitate a patient's limb by pushing, pulling, twisting, etc. A single rehabilitation session lasts about 20 to 30 minutes. Rehabilitation equipment with various rehabilitation functions will be set up separately for use by individual patient. If the patient is a moderate or severe stroke patient, because the muscle tone of the stroke patient is high, the rehabilitation therapist has to exert a greater force on the limb of the stroke patient. In the long run, not only the physical fitness of the rehabilitation therapist may be affected, but also occupational injury to the rehabilitation therapist may occur. Moreover, during rehabilitation, the patient may have to move and find the corresponding rehabilitation equipment to suit his/her rehabilitation requirement, which is inconvenient. In addition, the force exerted by different rehabilitation therapists cannot guarantee that the dosage of each rehabilitation session will be the same, so that the rehabilitation therapy effect cannot be quantified.

### SUMMARY

Therefore, an object of the present disclosure is to provide an upper limb rehabilitation device that can alleviate at least one of the drawbacks of the prior art.

According to one aspect of this disclosure, the upper limb rehabilitation device for rehabilitation of an upper limb of a patient includes a support mechanism, a flexion and extension rehabilitation mechanism, and a twist rehabilitation mechanism. The flexion and extension rehabilitation mechanism includes a sliding seat unit mounted on the support mechanism and movable forwardly and rearwardly relative to the same, and an arm rest seat mounted on the sliding seat unit for an arm of the upper limb of the patient to rest thereon. The arm rest seat is configured to be actuated by a flexion and extension movement of the arm of the upper limb of the patient to drive forward and rearward movement of the sliding seat unit relative to the support mechanism. The twist rehabilitation mechanism includes a handgrip unit mounted on the sliding seat unit and rotatable leftward and rightward relative to the same for a hand of the upper limb of the patient to grip.

### BRIEF DESCRIPTION OF THE DRAWINGS

Other features and advantages of the disclosure will become apparent in the following detailed description of the embodiment with reference to the accompanying drawings. It is noted that various features may not be drawn to scale.

FIG. 1 is a perspective view of an upper limb rehabilitation device according to an embodiment of the present disclosure.

FIG. 2 is a side view of the embodiment.

FIG. 3 is a fragmentary perspective view of the embodiment.

FIG. 4 is a view similar to FIG. 2, but with a guide rail unit of the embodiment being lowered relative to a base, a sliding seat unit being located on a rear end of the guide rail unit, and an arm rest seat and a handgrip unit being pivoted upwardly relative to a frame body.

FIG. 5 is a top view of the embodiment.

FIG. 6 is an enlarged fragmentary perspective view of an assembly of a sliding seat unit and a handgrip unit of the embodiment.

FIG. 7 is a functional block diagram of the embodiment.

FIG. 8 is a front sectional view of the embodiment, illustrating a positional relationship between the handgrip unit and left and right limit sensors.

FIG. 9 is a view similar to FIG. 8, but with a limiting member of the handgrip unit being in contact the right limit sensor.

### DETAILED DESCRIPTION

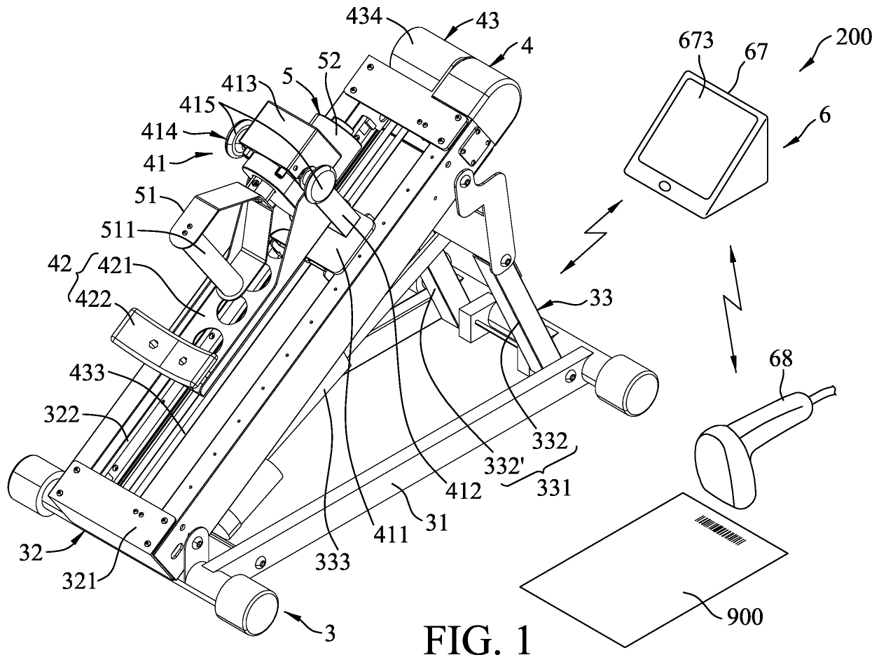

Referring to FIGS. 1 to 3, an upper limb rehabilitation device 200 according to an embodiment of the present disclosure is adapted for rehabilitation of an upper limb of a patient. The patient wears or carries an identification object 900 in which patient identification data is stored and can be read. The identification object 900 may be, for example but not limited to, an identification bracelet worn on a hand of the patient, or a medical record. The patient identification data may be, for example but not limited to, data recorded in a barcode form, which is, for example but not limited to, a medical record number.

The upper limb rehabilitation device 200 includes a support mechanism 3, a flexion and extension rehabilitation mechanism 4 mounted on the support mechanism 3, a twist rehabilitation mechanism 5 mounted on the flexion and extension rehabilitation mechanism 4, and a control device 6 signally connected to the support mechanism 3, the flexion and extension rehabilitation mechanism 4, and the twist rehabilitation mechanism 5.

The support mechanism 3 includes a base 31 for placement on a platform, such as a table top, a guide rail unit 32 extending in a front-rear direction, and a tilt adjustment unit 33 mounted between the base 31 and the guide rail unit 32. The guide rail unit 32 includes a main body 321 and two guide rails 322. The main body 321 has a rectangular structure, has a rear end portion pivotally connected to a rear end portion of the base 31, and is movable up and down relative to the base 31. The two guide rails 322 extend in the front-rear direction, and are disposed on left and right sides of the main body 321.

The tilt adjustment unit 33 includes a linkage module 331 pivotally connected between front end portions of the base 31 and the main body 321, and a tilt adjuster 333 pivotally connected between the rear end portion of the base 31 and the linkage module 331.

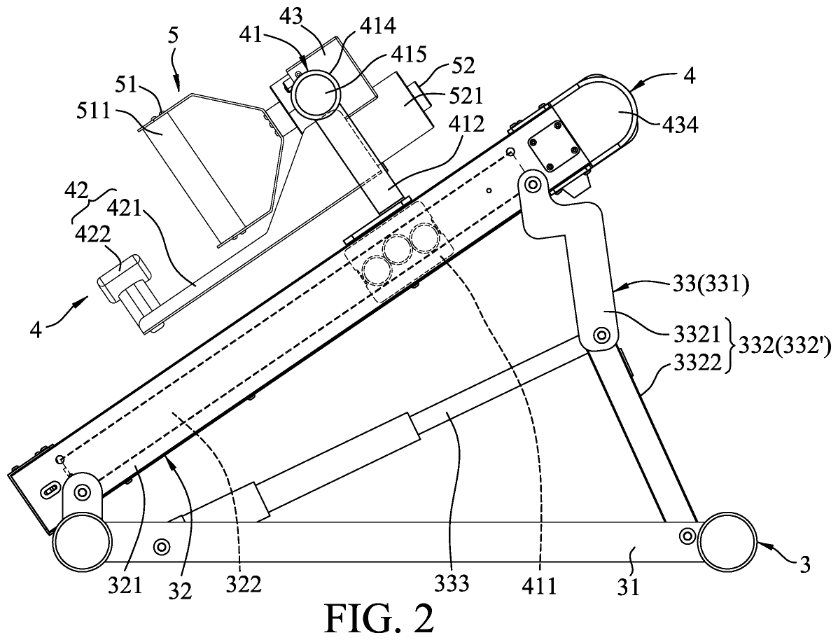

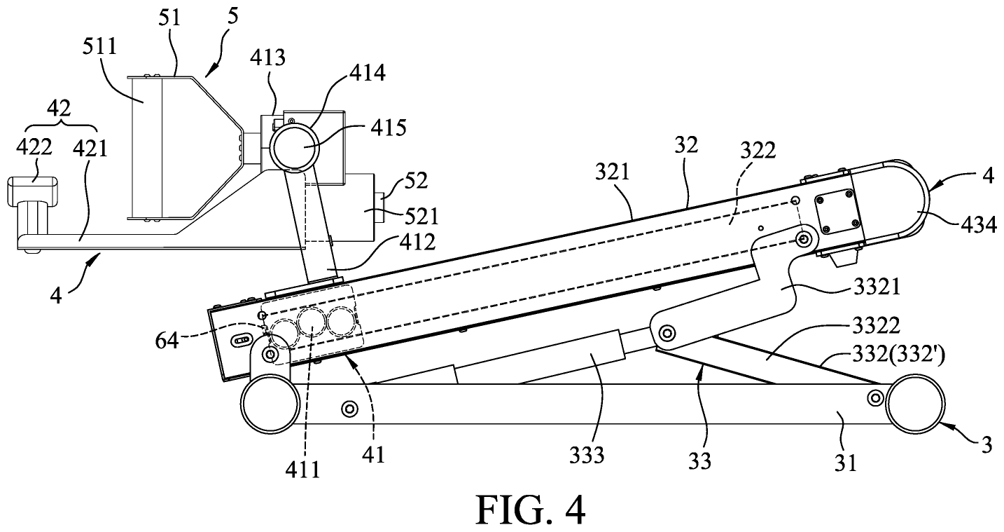

Referring to FIG. 4, in combination with FIGS. 1 and 2, in this embodiment, the linkage module 331 includes two links 332, 332′ and a pivot shaft 334. Each link 332, 332′ includes a first link segment 3321 and a second link segment 3322. The first link segment 3321 has one end pivoted to one of left and right outer sides of the front end portion of the main body 321, and the other end pivoted to one of left and right ends of the pivot shaft 334. The second link segment 3322 has one end pivoted to one of left and right inner sides of the front end portion of the base 31, and the other end pivoted to the pivot shaft 334 and located inwardly of the other end of the first link segment 3321. The first and second link segments 3321, 3322 are pivotable relative to each other about the pivot shaft 334. The tilt adjuster 333 is an electric cylinder signally connected to the control device 6, and has a front end pivoted to a central portion of the pivot shaft 334. The tilt adjuster 333 can be controlled by the control device 6 to extend or retract in the front-rear direction relative to the base 31 so as to change a length thereof and so as to push or pull the pivot shaft 334 to thereby straighten or bend the linkage module 331 in an up-down direction. The first and second link segments 3321, 3322 can pivot away from each other in the up-down direction when the pivot shaft 334 is pushed by the tilt adjuster 333 so as to push up the front end portion of the main body 321 relative to the base 31, as shown in FIG. 2, and can pivot toward each other in the up-down direction when the pivot shaft 334 is pulled by the tilt adjuster 333 so as to pull down the front end portion of the main body 321 relative to the base 31, as shown in FIG. 4, thereby changing a tilt angle of the guide rail unit 32 relative to the base 31.

Since the linkage module 331 can be driven to bend and straighten in the up-down direction, and since the structural design for driving the main body 321 to pivot up and down relative to the base 31 is known in the prior art and has many types, the implementation thereof is not limited to the aforesaid disclosure. Furthermore, in other embodiments of the present disclosure, the tilt adjuster 333 may be changed to a pneumatic cylinder, a hydraulic cylinder, or a screw rotation transmission method for driving the linkage module 331 to bend and straighten so as to change the tilt angle of the guide rail unit 32 relative to the base 31. Since there are many types of the tilt adjustment units 33 that can be used to adjust the tilt angle of the guide rail unit 32 relative to the base 31, implementation thereof is not limited to the aforesaid disclosure.

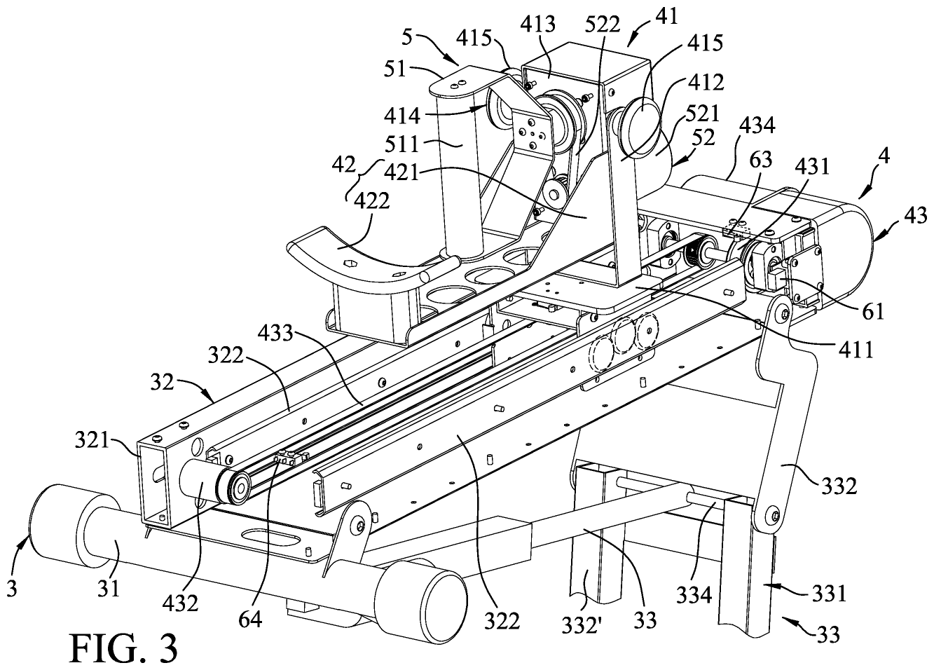

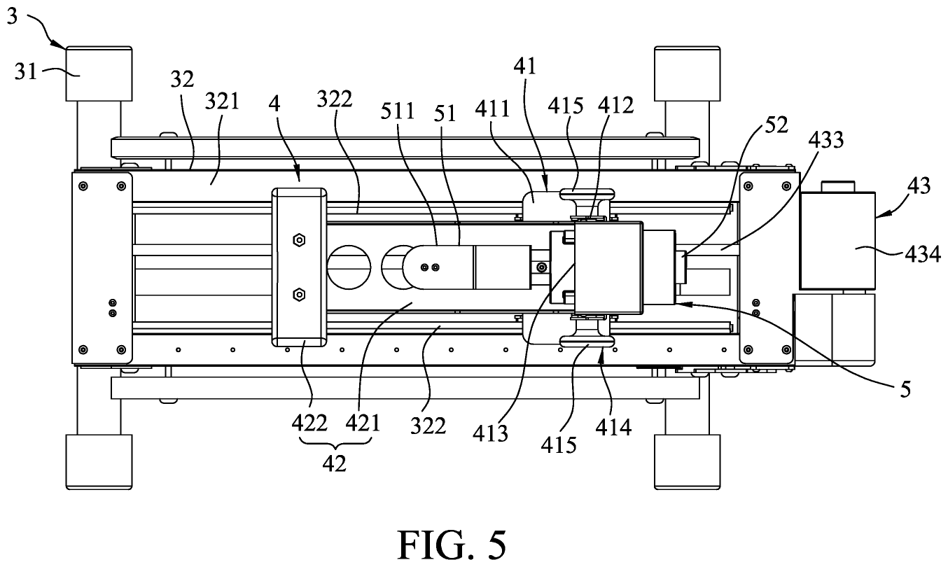

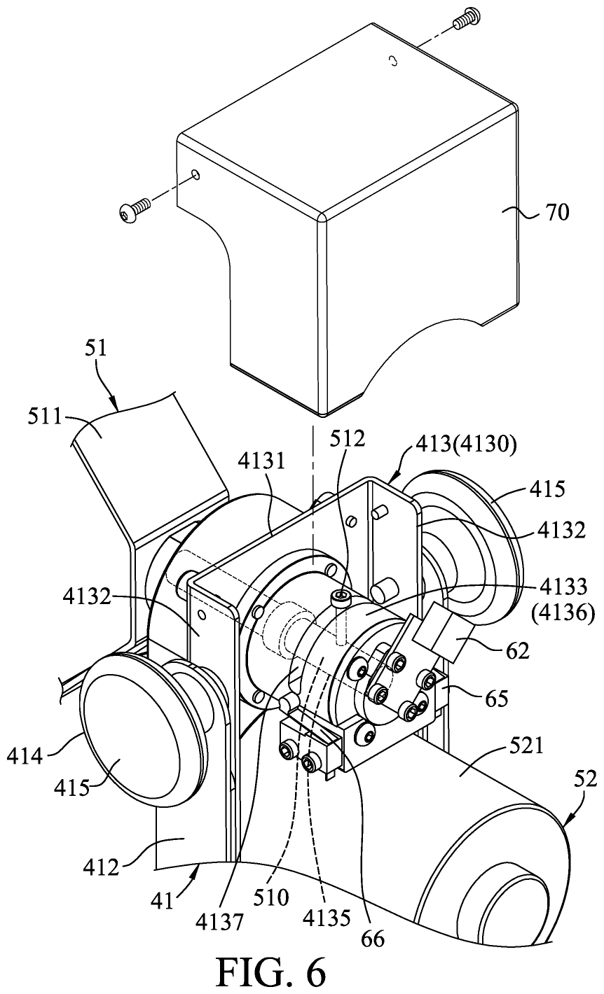

Referring to FIGS. 5 and 6, in combination with FIGS. 1 and 3, the flexion and extension rehabilitation mechanism 4 includes a sliding seat unit 41 disposed between the guide rails 322, an arm rest seat 42 connected to the sliding seat unit 41 for a forearm of the upper limb of the patient to rest thereon, and a flexion and extension drive unit 43 mounted on the main body 321 and connected to the sliding seat unit 41.

The sliding seat unit 41 includes a sliding seat 411 mounted on and movable forwardly and rearwardly along the guide rails 322, a U-shaped frame body 412 disposed on a top side of the sliding seat 411 and opening upwardly, a pivot seat 413 for mounting of the arm rest seat 42 and the twist rehabilitation mechanism 5 thereto, and a pivot assembly 414 for pivotally connecting the pivot seat 413 to the frame body 412 such that the pivot seat 413 is pivotable forward and rearward relative to the frame body 412.

The pivot seat 413 is disposed between left and right sides of the frame body 412, and includes a substantially U-shaped plate body 4130 having a middle plate portion 4131 and left and right plate portions 4132 extending outwardly and forwardly from left and right ends of the middle plate portion 4131, and a tubular structure 4133 extending outwardly and forwardly from the middle plate portion 4131. The tubular structure 4133 has an inner peripheral surface defining a central hole 4135, and an outer peripheral surface 4136 formed with an annular groove 4137 communicating with the central hole 4135. The pivot assembly 414 includes two bolts 415 extending respectively and threadedly through the left and right sides of the frame body 412 and engaged respectively and threadedly to the left and right plate portions 4132 of the pivot seat 413. The bolts 415 of the pivot assembly 414 are operable to move between a loosened state and a tightened state. When the bolts 415 are in the loosened state, the U-shaped plate body 4130 of the pivot seat 413 is not tightly fastened to the frame body 412 by the bolts 415, so that the pivot seat 413 is pivotable forward and rearward relative to the frame body 412. When the bolts 415 are in the tightened state, the bolts 415 cooperate with each other to lock the U-shaped plate body 4130 to the frame body 412 such that the pivot seat 413 is fixed to the frame body 412, and is thus unable to pivot forward and rearward relative to the frame body 412.

The arm rest seat 42 has an extension portion 421 extending in the front-rear direction and having a front end connected to the left and right plate portions 4132 of the pivot seat 413 in proximity to a bottom end thereof, and an arm rest portion 422 extending upwardly from a rear end of the extension portion 421 for the forearm to rest thereon.

The flexion and extension drive unit 43 includes a belt pulley 431 and an adjustment wheel 432 disposed on the main body 321 and spaced apart from each other in the front-rear direction, a transmission belt 433 looped around the adjustment wheel 432 and the belt pulley 431 and fixedly clamped to a bottom side of the sliding seat 411, and a motor assembly 434 mounted to a front end of the main body 321 and connected to the belt pulley 431. The belt pulley 431 and the adjustment wheel 432 are respectively located on front and rear inner sides of the sliding seat 411.

In this embodiment, the motor assembly 434 can be controlled and actuated by the control device 6 to drive the belt pulley 431 to rotate, so that the belt pulley 431 can in turn drive the transmission belt 433 to rotate, thereby driving the sliding seat 411 to move forward and rearward along the guide rails 322. Furthermore, when the motor assembly 434 is not actuated, the sliding seat 411 can be independently driven by the arm rest seat 42 to move freely forward and rearward along the guide rails 322 through a flexion and extension movement of the arm of the upper limb of the patient, and can simultaneously drive the transmission belt 433 to rotate the belt pulley 431.

The twist rehabilitation mechanism 5 includes a handgrip unit 51 connected to the pivot seat 413 for a hand of the upper limb of the patient to grip, and a rotary drive unit 52 connected to the middle plate portion 4131 of the pivot seat 413 and located below the tubular structure 4133.

With reference to FIGS. 1, 3, and 6, the handgrip unit 51 includes a shaft member 510 extending through the middle plate portion 4131 into the central hole 4135 of the tubular structure 4133 and having a front end portion extending out of a front end of the tubular structure 4133 and a rear end portion extending out of the middle plate portion 4131 at a side opposite to the tubular structure 4133, a handgrip member 511 connected to the rear end portion of the shaft member 510, and a limiting member 512 extending radially and outwardly from the front end portion of the shaft member 510 and located in the annular groove 4137 of the tubular structure 4133. The handgrip member 511 is located between the arm rest portion 422 and the pivot seat 413 for the hand of the upper limb of the patient to grip, can be driven to rotate leftward and rightward relative to the pivot seat 413, and can drive the limiting member 512 to rotate leftward and rightward within the annular groove 4137 through the shaft member 510.

The rotary drive unit 52 can be controlled by the control device 6 to drive the handgrip member 511 to rotate. In this embodiment, the rotary drive unit 52 includes a motor assembly 521, and a transmission belt 522 connected between the motor assembly 521 and the rear end portion of the shaft member 510. The motor assembly 521 can drive the shaft member 510 to rotate through the transmission belt 522, and the shaft member 510, in turn, can drive the handgrip member 511 to rotate therewith. However, in practice, because the rotary drive unit 52 for driving rotation of the handgrip member 511 in a left-right direction has many types, for example, a combination of a gear assembly and the motor assembly 521 may be used to drive rotation of the handgrip member 511, so the rotary drive unit 52 is not limited to the aforesaid embodiment.

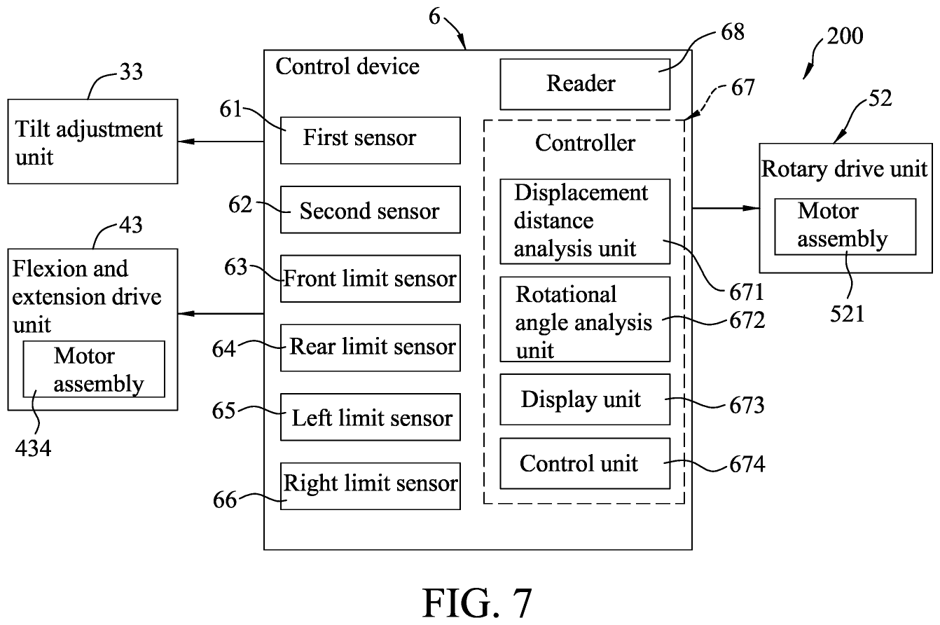

Referring to FIG. 7, in combination with FIGS. 1, 3, and 6, the control device 6 includes a first sensor 61 connected to the front end portion of the main body 321 for sensing a rotational angle of the belt pulley 431, a second sensor 62 connected to a front end of the shaft member 510 for sensing a rotational angle of the handgrip member 511, a front limit sensor 63 and a rear limit sensor 64 that are disposed on the seat body 321 and that are respectively adjacent to front and rear ends of the guide rail unit 32, a left limit sensor 65 and a right limit sensor 66 respectively disposed on left and right sides of the tubular structure 4133 of the pivot seat 413 and opposite to each other relative to a rotational axis of the handgrip member 511, a reader 68 for reading the patient identification data stored in the identification object 900, and a controller 67. The reader 68 can read the patient identification data of the identification object 900 through the use of image capture and analysis technology or optical scanning technology.

The first sensor 61 can generate a first sensing signal corresponding to a sensed rotational angle of the belt pulley 431. The second sensor 62 can generate a second sensing signal corresponding to a sensed rotational angle of the handgrip member 511. In this embodiment, each of the first and second sensors 61, 62 is a rotary encoder, and may be an optical or mechanical type. Since the first and second sensors 61, 62 used for sensing rotational angles are known in the art, and the types thereof are many, detailed description thereof is omitted herein for the sake of brevity.

The front and rear limit sensors 63, 64 are located on a displacement path of the sliding seat 411, and are used for respectively sensing a forward limit position and a rearward limit position of the sliding seat 411. When the front limit sensor 63 senses the sliding seat 411, it will generate a front limit sensing signal. When the rear limit sensor 64 senses the sliding seat 411, it will generate a rear limit sensing signal.

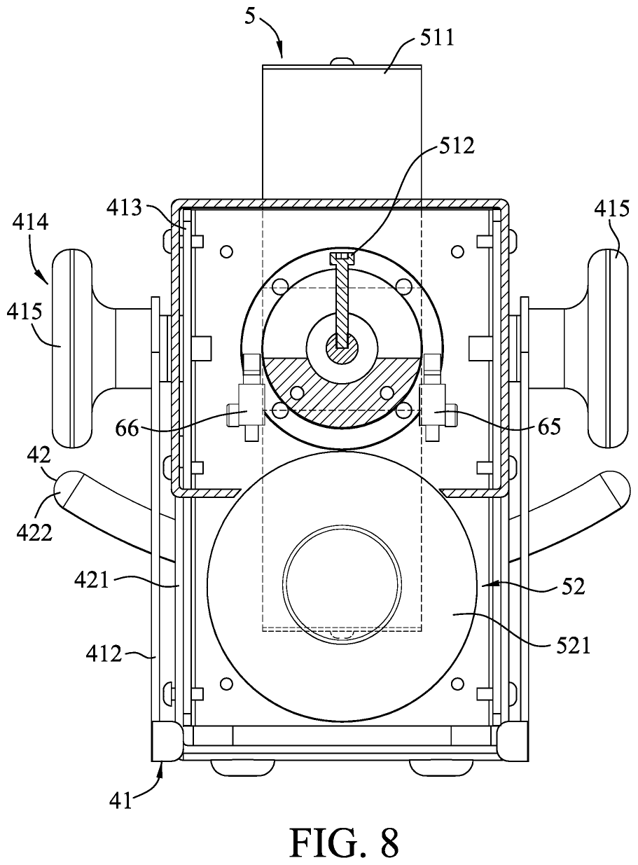

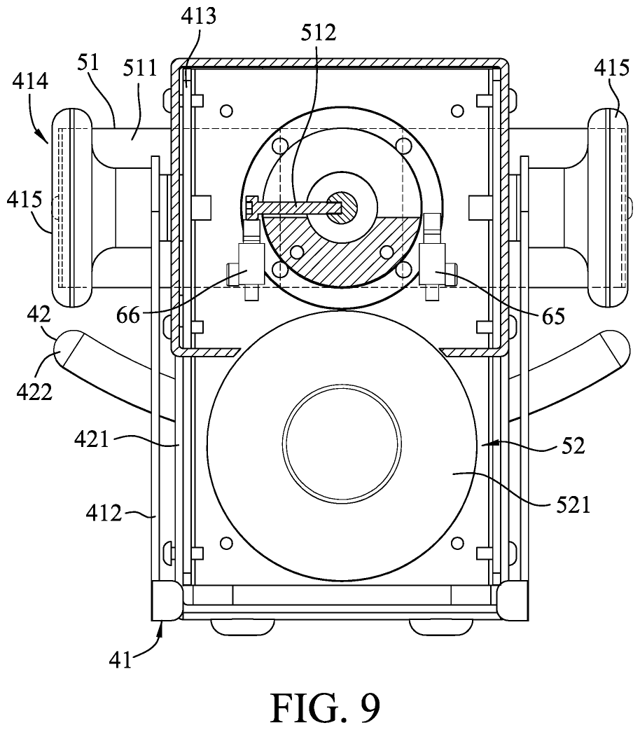

Referring to FIGS. 8 and 9, in combination with FIG. 6, the left and right limit sensors 65, 66 are used for respectively sensing left and right rotational limit positions of the handgrip member 511. When the left limit sensor 65 senses the limiting member 512, it will generate a left limit sensing signal. When the right limit sensor 66 senses the limiting member 512, it will generate a right limit sensing signal.

Referring back to FIGS. 3, 6, 7, in this embodiment, each of the front and rear limit sensors 63, 64 is a micro switch that can be triggered by the sliding seat 411, and each of the left and right limit sensors 65, 66 is a micro switch that can be triggered by the limiting member 512. However, in other embodiments of the present disclosure, the front and rear limit sensors 63, 64 and the left and right limit sensors 65, 66 may be changed to other ways for respectively sensing the sliding seat 411 and the limiting member 512, for example, but not limited to, using optical sensing technology or magnetic induction technology. Since the front limit sensor 63, the rear limit sensor 64, the left limit sensor 65, and the right limit sensor 66 are of many types, details thereof are omitted herein, and are not limited to the aforesaid embodiment. A cover 70 is connected to the pivot seat 413 to protect the tubular structure 4133, the limiting member 512, the second sensor 62, and the left and right limit sensors 65, 66.

The controller 67 is signally connected to the first and second sensors 61, 62, the front and rear limit sensors 63, 64, and the left and right limit sensors 65, 66, and is further signally connected to the tilt adjuster 333 and the motor assemblies 434 and 521. The controller 67 includes a displacement distance analysis unit 671, a rotational angle analysis unit 672, a display unit 673, and a control unit 674.

The displacement distance analysis unit 671 can analyze the first sensing signal to obtain a displacement distance of the sliding seat 411 when it is driven to move forward or rearward. The rotational angle analysis unit 672 can analyze the second sensing signal to obtain an angle of the handgrip member 511 when it is driven to rotate leftward or rightward.

The control unit 674 is operable to control operation of the tilt adjuster 333 for adjusting the tilt angle of the guide rail unit 32 relative to the base 31. The control unit 674 has an active mode, a passive mode, an auxiliary passive mode, a somatosensory training mode, and a programming mode that are built therein. The control unit 674 will display an operation interface (not shown) on the display unit 673 that can be operated to set and selectively activate the modes. In this embodiment, the display unit 673 is a touch display, but is not limited thereto.

When the control unit 674 is operated to execute the active mode, the motor assemblies 434 and 521 will not be activated by the control unit 674, the sliding seat unit 41 can be driven by the patient to freely move forward and rearward relative to the guide rail unit 32, and the handgrip unit 51 can be operated by the patient to freely rotate leftward and rightward relative to the sliding seat unit 41. Moreover, the control unit 674 can be used to set a predetermined rehabilitation distance for the forward and/or rearward movement of the sliding seat unit 41, a predetermined rehabilitation angle for the left and/or right rotation of the handgrip member 511, number of flexion and extension rehabilitation repetition, and number of rotational rehabilitation repetition through the operation interface.

When the sliding seat unit 41 is driven to move forward and rearward, the belt pulley 431 is synchronously driven to rotate, and the first sensor 61 will sense the rotation of the belt pulley 431 and generate the first sensing signal. The displacement distance analysis unit 671 will analyze the first sensing signal and obtain a forward or rearward displacement distance of the sliding seat 411. When the displacement distance reaches the predetermined rehabilitation distance, the displacement distance analysis unit 671 will accumulate one flexion and extension rehabilitation repetition. When the handgrip unit 51 is operated to rotate leftward and rightward, the second sensor 62 can synchronously sense and generate the second sensing signal. The rotational angle analysis unit 672 will analyze the second sensing signal and obtain a left or right rotational angle of the handgrip member 511. When the rotational angle reaches the predetermined rehabilitation angle, the rotational angle analysis unit 672 will accumulate one rotational rehabilitation repetition. The control unit 674 will simultaneously show the displacement distance and the rotational angle at the display unit 673, as well as the accumulated number of the flexion and extension rehabilitation repetition and the number of the rotational rehabilitation repetition.

When the control unit 674 is switched to the passive mode, a predetermined rehabilitation distance, a displacement speed, a predetermined rehabilitation angle, a rotational speed, a flexion and extension stay time, a rotational stay time, number of the flexion and extension rehabilitation repetition, and number of the rotational rehabilitation repetition can all be set by the control unit 674 through the operation interface.

When the control unit 674 is operated to execute the passive mode, the control unit 674 will correspondingly control the operation of the motor assembly 434 according to the displacement distance analyzed and obtained by the displacement distance analysis unit 671, so that the flexion and extension drive unit 43 can drive the sliding seat 411 to move forwardly or rearwardly to the predetermined rehabilitation distance relative to the guide rail unit 32 at the displacement speed and remain at the position of the predetermined rehabilitation distance for the flexion and extension stay time. Thereafter, the control unit 674 will again control the operation of the motor assembly 434 to move the sliding seat 411 back to an initial position and accumulate one flexion and extension rehabilitation repetition.

The control unit 674 will correspondingly control the operation of the motor assembly 521 according to the rotational angle analyzed and obtained by the rotational angle analysis unit 672, so that the rotary drive unit 52 can drive the handgrip member 511 to rotate leftward or rightward to the predetermined rehabilitation angle relative to the sliding seat unit 41 at the rotational speed and remain at the position of the predetermined rotational angle for the rotational stay time. Thereafter, the control unit 674 will again control the operation of the motor assembly 521 to rotate the handgrip member 511 back to an initial position and accumulate one rotational rehabilitation repetition.

When the control unit 674 is switched to the auxiliary passive mode, the control unit 674 can similarly be operated to set a predetermined rehabilitation distance, a displacement speed, a predetermined rehabilitation angle, a rotational speed, a flexion and extension stay time, a rotational stay time, number of flexion and extension rehabilitation repetition, and number of the rotational rehabilitation repetition, and can be further operated to set a flexion and extension limit time and a rotational limit time.

When the control unit 674 is operated to execute the auxiliary passive mode, the control unit 674 is first switched to execute the active mode in order to analyze the first and second sensing signals and to respectively obtain a forward or rearward displacement distance of the sliding seat 411 and a left or right rotational angle of the handgrip member 511. Furthermore, the control unit 674 will determine whether the displacement distance reaches the predetermined rehabilitation distance within the flexion and extension limit time and whether the rotational angle reaches the predetermined rehabilitation angle within the rotational limit time.

The control unit 674 is switched to execute the passive mode when it has determined that the forward or rearward displacement distance of the sliding seat 411 has not reached the predetermined rehabilitation distance within the flexion and extension limit time, and will then control the flexion and extension drive unit 43 to activate and drive the sliding seat 411 to move to the position of the predetermined rehabilitation distance in a predetermined direction at the displacement speed and remain at the predetermined rehabilitation distance for the flexion and extension stay time. At this time, one flexion and extension rehabilitation repetition is recorded. Thereafter, the control unit 674 is switched to execute the active mode, so that the sliding seat 411 can be actively operated by the patient to move back to the initial position.

The control unit 674 is switched to execute the passive mode when it has determined that the rotational angle of the handgrip member 511 has not reached the predetermined rotational angle within the rotational limit time. The control unit 674 will then control the rotary drive unit 52 to activate and drive the handgrip member 511 to rotate to the position of the predetermined rotational angle in a predetermined direction at the rotational speed and remain at the predetermined rehabilitation angle for the rotational stay time. At this time, one rotational rehabilitation repetition is recorded. Next, the control unit 674 is switched to execute the active mode to allow the patient to rotate the handgrip member 511 back to the initial position.

When the control unit 674 is switched to the somatosensory training mode, the control unit 674 can similarly be operated to set a predetermined rehabilitation distance, a displacement speed, a predetermined rehabilitation angle, a rotational speed, a flexion and extension stay time, a rotational stay time, number of the flexion and extension rehabilitation repetition, and number of the rotational rehabilitation repetition, and can further be operated to set a voluntary flexion and extension movement time and a voluntary rotational movement time.

When the control unit 674 is operated to execute the somatosensory training mode, the control unit 674 is first switched to execute the passive mode, and according to the set content, the control unit 674 will control the flexion and extension drive unit 43 to activate and drive the sliding seat unit 41 together with the arm rest seat 42 to move and stay so as to accumulate the number of the flexion and extension rehabilitation repetition, and control the rotary drive unit 52 to activate and drive the handgrip member 511 to rotate and stay so as to accumulate the number of the rotational rehabilitation repetition. After each time the control unit 674 controls the sliding seat unit 41 to remain at the position of the predetermined rehabilitation distance for the flexion and extension stay time, the control unit 674 is switched to execute the active mode and continue the voluntary flexion and extension movement time, so that the patient can voluntarily perform his/her arm flexion and extension movement. Afterwards, the control unit 674 will repeat to execute the passive mode and the active mode until the desired accumulated number of the flexion and extension rehabilitation repetition is reached. Furthermore, after each time the control unit 674 controls the handgrip member 511 to remain at the predetermined rehabilitation angle for the rotational stay time, the control unit 674 is switched to execute the active mode and continue the voluntary rotational movement time, so that the patient can voluntarily perform his/her arm rotational movement. Afterwards, the control unit 674 will repeat to execute the passive mode and the active mode until the desired accumulated number of the rotational rehabilitation repetition is reached.

When the control unit 674 is switched to the programming mode, the control unit 674 is operable to set the order and number of repetition of the active mode, the passive mode, the auxiliary passive mode, and/or the somatosensory training mode to be executed so as to create a rehabilitation program. Furthermore, the control unit 674 is operable to set the predetermined rehabilitation distance, the displacement speed, the predetermined rehabilitation angle, the rotational speed, the flexion and extension stay time, the rotational stay time, the flexion and extension limit time, the rotational limit time, the voluntary flexion and extension movement time, the voluntary rotational movement time, the number of the flexion and extension rehabilitation repetition, and the number of the rotational rehabilitation for the aforementioned various modes.

When the control unit 674 is operated to execute the rehabilitation program of the programming mode, the operation of the flexion and extension drive unit 43 and/or the rotary drive unit 52 are correspondingly controlled according to the order and the number of repetition of the active mode, the passive mode, the auxiliary passive mode, and/or the somatosensory training mode programmed in the rehabilitation program, and according to the various time and repetition each mode is set in the rehabilitation program. Through this, the rehabilitation training of the upper limb of the patient can be programmed.

The control unit 674 can be further triggered by the front limit sensing signal of the front limit sensor 63 and the rear limit sensing signal of the rear limit sensor 64 during execution of the passive mode, the auxiliary passive mode, the somatosensory training mode, and the programming mode to control the flexion and extension drive unit 43 to stop driving the sliding seat 411 to move forward and rearward. That is, when the front limit sensor 63 senses the sliding seat 411, the control unit 674 will control the flexion and extension drive unit 43 to stop driving the sliding seat 411 to move forward; and when the rear limit sensor 64 senses the sliding seat 411, the control unit 674 will control the flexion and extension drive unit 43 to stop driving the sliding seat 411 to move rearward. Moreover, the control unit 674 can be further triggered by the left limit sensing signal of the left limit sensor 65 and the right limit sensing signal of the right limit sensor 66 to control the rotary drive unit 52 to stop driving the handgrip unit 51 to rotate leftward and rightward. That is, when the left limit sensor 65 senses the limiting member 512, the control unit 674 will control the rotary drive unit 52 to stop driving the handgrip member 511 to rotate leftward through the shaft member 510; and when the right limit sensor 66 senses the limiting member 512, the control unit 674 will control the rotary drive unit 52 to stop driving the handgrip member 511 to rotate rightward through the shaft member 510.

During operation of the control unit 674 to execute the active mode, the passive mode, the auxiliary passive mode, the motion sensing training mode, and the programming mode, in addition to analyzing the displacement distance data obtained from the first sensing signal and analyzing the rotational angle data obtained from the second sensing signal, the action process of controlling the flexion and extension drive unit 43 and/or the rotary drive unit 52 can also be recorded by the control unit 674 to create a control record.

When the reader 68 reads the patient identification data of the identification object 900, and the control unit 674 is subsequently operated to execute the active mode, the passive mode, the auxiliary passive mode, the somatosensory training mode, and/or the programming mode, the control unit 674 will collect and organize the patient identification data, the set predetermined rehabilitation distance and the displacement speed, the set predetermined rehabilitation angle and the rotational speed, the set flexion and extension stay time and the rotational stay time, the set flexion and extension limit time and the rotational limit time, the set voluntary flexion and extension movement time and the voluntary rotational movement time, the set number of the flexion and extension rehabilitation and the rotational rehabilitation repetitions, and the displacement distance data, the rotational angle data and the control record of each mode so as to create a rehabilitation historical data and store the same. In practice, the control unit 674 can transmit the rehabilitation historical data to a remote server (not shown) for storage through various currently known wireless communication technologies.

To use the upper limb rehabilitation device 200 of the present disclosure, the rehabilitation therapist can first read the patient identification data on the identification object 900 provided by the patient using the reader 68. After the patient places his/her forearm on the arm rest portion 422 of the arm rest seat 42 with his/her hand gripping the handgrip member 511, the rehabilitation therapist can then operate the control unit 674 according to a predetermined rehabilitation training method of the patient to switch and execute the corresponding ones of the active mode, the passive mode, the auxiliary passive mode, the somatosensory training mode, and the programming mode, and to set the predetermined rehabilitation distance and the displacement speed, the predetermined rehabilitation angle and the rotational speed, the flexion and extension stay time and the rotational stay time, the flexion and extension limit time and the rotational limit time, the voluntary flexion and extension movement time and the voluntary rotational movement time, and the number of the flexion and extension rehabilitation and the rotational rehabilitation repetitions.

After all the rehabilitation training is completed, the control unit 674 will create the rehabilitation historical data based on the patient identification data.

When the control unit 674 executes the above modes, the relevant time, speed and number of repetition can be set only for the flexion and extension rehabilitation to perform the flexion and extension rehabilitation training; or the relevant time, speed and number of repetitions can be set only for the rotational rehabilitation training to perform the arm rotation rehabilitation training. When the flexion and extension rehabilitation training and the rotational rehabilitation training of the upper limb of the patient are simultaneously set, the flexion and extension rehabilitation training and the rotational rehabilitation training can be performed separately, for example, but not limited to, all the repetitions of the flexion and extension rehabilitation training are performed first, after which all the repetitions of the rotational rehabilitation training are performed.

In summary, through the structural design of the sliding seat unit 41 and the arm rest seat 42 of the flexion and extension rehabilitation mechanism 4, and through the structural design of the twist rehabilitation mechanism 5, the flexion and extension rehabilitation function and the rotational rehabilitation function can be integrated together to facilitate the patient to perform the flexion and extension rehabilitation training and the rotational rehabilitation training of his/her upper limb at the same time. Furthermore, through the structural designs of the flexion and extension drive unit 43 of the flexion and extension rehabilitation mechanism 4 and the rotary drive unit 52 of the twist rehabilitation mechanism 5, and through the configuration of the control device 6, patients who cannot rehabilitate by themselves can be conveniently assisted through electronic control to perform rehabilitation of his/her upper limb, and the burden on the rehabilitation therapists can be reduced. Moreover, through the program control method, a rehabilitation dose can be controlled to ensure quantification of the curative effect. Therefore, the upper limb rehabilitation device 200 of this disclosure is indeed quite novel, is convenient to use, and can indeed achieve the object thereof.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An upper limb rehabilitation device for rehabilitation of an upper limb of a patient, comprising:
a support mechanism;
a flexion and extension rehabilitation mechanism including a sliding seat unit mounted on said support mechanism and movable forwardly and rearwardly relative to said support mechanism, and an arm rest seat mounted on said sliding seat unit for an arm of the upper limb of the patient to rest thereon, said arm rest seat being configured to be actuated by a flexion and extension movement of the arm of the upper limb of the patient to drive forward and rearward movement of said sliding seat unit relative to said support mechanism; and
a twist rehabilitation mechanism including a handgrip unit mounted on said sliding seat unit and rotatable leftward and rightward relative to said sliding seat unit for a hand of the upper limb of the patient to grip.

2. The upper limb rehabilitation device as claimed in claim 1, wherein said flexion and extension rehabilitation mechanism further includes a flexion and extension drive unit mounted on said support mechanism and connected to said sliding seat unit, said flexion and extension drive unit being activated to drive the forward and rearward movement of said sliding seat unit relative to said support mechanism.

3. The upper limb rehabilitation device as claimed in claim 2, wherein said twist rehabilitation mechanism further includes a rotary drive unit mounted on said sliding seat unit and connected to said handgrip unit, said rotary drive unit being activated to drive left and right rotation of said handgrip unit relative to said sliding seat unit.

4. The upper limb rehabilitation device as claimed in claim 3, further comprising a control device which includes a controller signally connected to said flexion and extension drive unit and said rotary drive unit, said controller having an active mode and a passive mode that are built therein, wherein, when said controller is operated to execute said active mode, said flexion and extension drive unit and said rotary drive unit will not be activated by said controller, said sliding seat unit is freely movable relative to said support mechanism, and said handgrip unit is freely rotatable relative to said sliding seat unit; and when said controller is operated to execute said passive mode, said flexion and extension drive unit and/or said rotary drive unit are controlled by said controller to activate.

5. The upper limb rehabilitation device as claimed in claim 4, wherein:
said control device further includes a first sensor for sensing movement of said flexion and extension drive unit and generating a first sensing signal, and a second sensor for sensing left and right rotation of said handgrip unit relative to said sliding seat unit and generating a second sensing signal;
said controller further has an auxiliary passive mode that is built therein;
when said controller is operated to execute said auxiliary passive mode, said controller is first switched to execute said active mode in order to analyze said first sensing signal and obtain a forward or rearward displacement distance of said sliding seat unit through said flexion and extension drive unit and to analyze said second sensing signal and obtain a left or right rotational angle of said handgrip unit;
said controller is configured to switch to said passive mode when:
said controller has determined that said forward or rearward displacement distance of said sliding seat unit has not reached a predetermined rehabilitation distance within a flexion and extension limit time, and will then control said flexion and extension drive unit to activate and drive said sliding seat unit to move to said predetermined rehabilitation distance in a predetermined direction; and said controller has determined that said rotational angle of said handgrip unit has not reached a predetermined rehabilitation angle within a rotational limit time, and will then control said rotary drive unit to activate and drive said handgrip unit to rotate to said predetermined rehabilitation angle in a predetermined direction.

6. The upper limb rehabilitation device as claimed in claim 5, wherein:
said controller further has a somatosensory training mode built therein;
when said controller is operated to execute said somatosensory training mode, said controller is first switched to execute said passive mode in order to analyze said first sensing signal and obtain said forward or rearward displacement distance of said sliding seat unit and/or analyze said second sensing signal to obtain said left or right rotational angle of said handgrip unit;
said controller is configured to control said flexion and extension drive unit to activate and drive said sliding seat unit to move to said predetermined rehabilitation distance in the predetermined direction and remain for a flexion and extension stay time according to said forward or rearward displacement distance of said sliding seat unit obtained from analyzing said first sensing signal, after which said controller is switched to execute said active mode; and
said controller is configured to control said rotary drive unit (52) to activate and drive said handgrip unit to rotate to said predetermined rehabilitation angle in the predetermined direction and remain for a rotational stay time according to said left or right rotational angle obtained from analyzing said second sensing signal, after which said controller is switched to execute said active mode.

7. The upper limb rehabilitation device as claimed in claim 6, wherein:
said controller further has a programming mode built therein;
when said controller is operated and switched to said programming mode, said controller is operable to set the order and number of repetition of said active mode, said passive mode, said auxiliary passive mode and/or said somatosensory training mode to be executed so as to create a rehabilitation program; and
when said controller is operated to execute said rehabilitation program, said controller will control operation of said flexion and extension drive unit and/or said rotary drive unit according to the order and number of repetition of said active mode, said passive mode, said auxiliary passive mode, and/or said somatosensory training mode programmed in said rehabilitation program.

8. The upper limb rehabilitation device as claimed in claim 4, wherein said control device further includes a front limit sensor and a rear limit sensor that are mounted on said support mechanism, that are spaced apart from each other in a front-rear direction, and that are located on a displacement path of said sliding seat unit, said controller being further signally connected to said front limit sensor and said rear limit sensor, and wherein, when said controller is operated to execute said passive mode, said controller will control said flexion and extension drive unit to stop driving said sliding seat unit to move forward when said front limit sensor senses said sliding seat unit, and will control said flexion and extension drive unit) to stop driving said sliding seat unit to move rearward when said rear limit sensor senses said sliding seat unit.

9. The upper limb rehabilitation device as claimed in claim 4, wherein said control device further includes a left limit sensor and a right limit sensor disposed on said sliding seat unit and opposite to each other relative to a rotational axis of said handgrip unit, said handgrip unit including a shaft member rotatably connected to said sliding seat unit a handgrip member connected to a rear end portion of said shaft member and rotatable leftward and rightward relative to said sliding seat unit through said shaft member, and a limiting member protruding radially and outwardly from a front end portion of said shaft member, said rotary drive unit being connected to said shaft member, said controller being further signally connected to said left limit sensor and said right limit sensor, and wherein, when said controller is operated to execute said passive mode, said controller will control said rotary drive unit to stop driving said handgrip member to rotate leftward through said shaft member when said left limit sensor senses said limiting member, and will control said rotary drive unit to stop driving said handgrip member to rotate rightward through said shaft member when said right limit sensor senses said limiting member.

10. The upper limb rehabilitation device as claimed in claim 5, wherein said flexion and extension drive unit includes a belt pulley and an adjustment wheel spaced apart from each other in a front-rear direction, a transmission belt looped around said belt pulley and said adjustment wheel and connected to said sliding seat unit, and a motor assembly for driving rotation of said belt pulley, said belt pulley being rotatable to drive said transmission belt to move said sliding seat unit forward and rearward relative to said support mechanism, said sliding seat unit being pushed and pulled forward and rearward by one of said arm rest seat and said handgrip unit to drive said transmission belt to rotate said belt pulley, said first sensor generating said first sensing signal when sensing a rotational angle of said belt pulley.

11. The upper limb rehabilitation device as claimed in claim 1, wherein said support mechanism includes a base configured to be disposed on a platform, a guide rail unit extending in a front-rear direction and having a rear end portion that is pivotally connected to said base and that is pivotable up and down relative to said base, and a tilt adjustment unit mounted between said base and said guide rail unit, said tilt adjustment unit being operable to drive said guide rail unit to pivot up and down relative to said base, said sliding seat unit being mounted on said guide rail unit and being movable forwardly and rearwardly along said guide rail unit.

12. The upper limb rehabilitation device as claimed in claim 11, wherein said tilt adjustment unit includes a linkage module pivotally connected between said guide rail unit and said base, and a tilt adjuster pivotally connected between said base and said linkage module, said tilt adjuster being controllable to drive said linkage module to bend and straighten in an up-down direction, which in turn drives said guide rail unit to pivot up and down relative to said base so as to adjust a tilt angle of said guide rail unit relative to said base.

13. The upper limb rehabilitation device as claimed in claim 11, wherein said sliding seat unit includes a sliding seat mounted on said guide rail unit and movable forward and rearward relative to said guide rail unit, a frame body disposed on said sliding seat, a pivot seat for mounting of said handgrip unit and said arm rest seat thereto, and a pivot assembly for mounting said pivot seat on said frame body such that said pivot seat is pivotable forward and rearward relative to said frame body, said pivot assembly being operable to move between a loosened state, in which said pivot seat is pivotable forward and rearward relative to said frame body, and a tightened state, in which said pivot seat is fixed to said frame body.

14. The upper limb rehabilitation device as claimed in claim 7, wherein:
said upper limb rehabilitation device is adapted to be used with patient identification data on an identification object of a patient;
said control device further includes a reader for reading the patient identification data on the identification object; and
said controller is further signally connected to said reader, and includes a control unit configured to collect and organize the patient identification data read by said reader, displacement distance data obtained from said first sensing signal, a rotational angle data obtained from said second sensing signal, and a control record of actuation of said flexion and extension drive unit and/or said rotary drive unit when said drive mode, said passive mode, said auxiliary passive mode, said somatosensory training mode, and/or said programming mode are activated, and then to create a rehabilitation historical data.
